(19) United States
(12) Patent Application Publication
(10) Pub. No.: US 2026/0156717 A1
(43) Pub. Date: Jun. 4, 2026

(54) DEVICE FOR THE ELECTRICAL CONTACTING OF A HEATING CONDUCTOR

(71) Applicant: Schaeffler Technologies AG & Co. KG, Herzogenaurach (DE)

(72) Inventors: Rolf BRÜCK, Bergisch Gladbach (DE); Peter HIRTH, Rösrath (DE); Stefan AHLERS, Bergisch Gladbach (DE)

(21) Appl. No.: 19/123,606

(22) PCT Filed: Oct. 19, 2023
(86) PCT No.: PCT/EP2023/079184

§ 371 Date: Apr. 23, 2025

(30) Foreign Application Priority Data
Oct. 31, 2022 (DE) 10 2022 211 524.4

(51) Int. Cl. H05B 3/08; H05B 3/04

(52) U.S. Cl. CPC H05B 3/08; H05B 3/04; H05B 2203/016; H05B 2203/022

(57) ABSTRACT

A device for the electrical contacting of a heating conductor in an exhaust gas line. The heating conductor is arranged within a metal housing and at least one electrical conductor is fed through this housing in order to contact the heating conductor inside, with an insulator, which is designed as a sleeve. The sleeve has a central bore, through which the electrical conductor is fed. The insulator has on its radially outwardly directed surface a first metallized zone, to which a first metal sleeve is durably connected, and the insulator also has on its radially outwardly directed surface a second metallized zone, to which a second metal sleeve is durably connected.

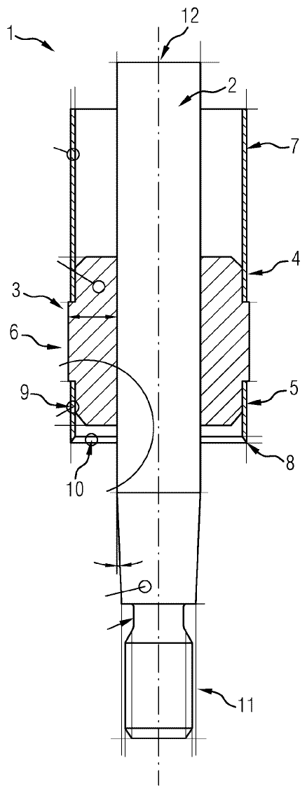

### CROSS REFERENCE TO RELATED APPLICATIONS

This is a U.S. national stage of Application No. PCT/EP 2023/079184 filed Oct. 19, 2023. Priority is claimed on German Application No. DE 10 2022 211 524.4 filed Oct. 31, 2022, the contents of which are incorporated herein by reference.

### BACKGROUND OF THE INVENTION

### 1. Field of the Invention

The disclosure relates to a device for the electrical contacting of a heating conductor in an exhaust gas line, wherein the heating conductor is arranged within a metal housing and at least one electrical conductor is fed through this housing to contact the heating conductor inside, with an insulator, which is designed as a sleeve, wherein the sleeve has a central bore, through which the electrical conductor is fed.

### 2. Description of the Related Art

Nowadays, electrical heating elements are often used to heat exhaust gases in an exhaust gas line downstream of an internal combustion engine, or the exhaust gas flowing in an exhaust gas line. The aim here is to more quickly reach a temperature threshold from which effective transformation of the pollutants entrained in the exhaust gas can take place. This is necessary because the catalytically active surfaces, used for exhaust gas aftertreatment, of the catalytic converters installed in the exhaust gas line only allow sufficient conversion of the respective pollutants from a minimum temperature, known as the light-off temperature.

The known solutions in the prior art include what are known as heated catalytic converters, which have a metallic structure connected to a voltage source or a metal-coated ceramic structure which can be heated up by exploiting ohmic resistance.

For the purpose of electrically contacting the heatable structure, an electrical conductor must be fed in through the housing of the exhaust gas line, or of a catalytic converter arranged in the exhaust gas line, at at least one point. It must be ensured here that the feedthrough is gas-tight, and also that there is electrical insulation between the housing and the electrical conductor, and that sufficient durability is ensured. The electrical conductor is often formed from a solid material, such as for example by a metal bolt.

DE 10 2012 110 098 B4 discloses a method for producing an electrical feedthrough for the power supply of an electrical exhaust-operated air heating in a motor vehicle. The feedthrough has an outer tube, with an electrical conductor passing through the interior thereof. The electrical conductor protrudes beyond the outer tube at at least one of the end faces of the outer tube. The electrical conductor is surrounded in the interior of the outer tube by an insulating material. The feedthrough is created here by trimming a compressed rod material to length, wherein in each case areas of the portion functioning as the outer tube and of the portion functioning as the insulating material are removed by machining methods in order to thus create an electrical feedthrough of the desired length with a desired projection of the electrical conductor beyond the outer tube.

A disadvantage of the methods known in the prior art for producing an electrical feedthrough is in particular that the compressed rod material used is very expensive because it has a multi-layered structure. In addition, the machining to release the electrical conductor and to trim the electrical feedthrough to length destroys, and therefore wastes, a significant proportion of approximately two-thirds of the rod material by machining as unused. The production process is therefore particularly complex and cost-intensive.

In addition, the known solutions from the prior art are often characterized by low gas tightness and low resistance to moisture. Electrocorrosion also occurs, in particular in applications with an operating voltage of 48 volts, which negatively affects the durability.

### SUMMARY OF THE INVENTION

Therefore, the problem addressed by the present disclosure is that of providing a device which allows improved electrical contacting of the heating conductor inside the housing and is at the same time improved in terms of gas tightness and corrosion resistance.

An exemplary aspect of the invention relates to a device for the electrical contacting of a heating conductor in an exhaust gas line, wherein the heating conductor is arranged within a metal housing and at least one electrical conductor is fed through this housing in order to contact the heating conductor inside, with an insulator, which is designed as a sleeve, wherein the sleeve has a central bore, through which the electrical conductor is fed, wherein the insulator has on its radially outwardly directed surface a first metallized zone, to which a first metal sleeve is durably connected, and the insulator also has on its radially outwardly directed surface a second metallized zone, to which a second metal sleeve is durably connected.

The insulator is preferably formed by a sleeve which has a continuous bore along its axial extent. The insulator thus has an annular cross section. The bore runs along the center axis of the insulator and the insulator is preferably formed rotationally symmetrically around its center axis. The axial direction describes the extent along the bore or the center axis, whereas the radial direction describes a normal to the center axis.

The insulator is preferably made of an electrically insulating material, such as in particular a ceramic material. The insulator may for example be produced from a powdered oxide ceramic by sintering or pressing.

The bore is preferably dimensioned such that the electrical conductor, which can also be referred to as the inner conductor, can be inserted precisely into this bore. It must be noted in particular here that the electrical conductor is made of a metallic material, preferably a 2.4869 steel, and thus has a different expansion behavior under the influence of heat than the insulator formed from a ceramic. The dimensioning of the bore must therefore be such that the expansion of the electrical conductor does not lead to damage to the insulator.

The metallized zones are areas on the outer circumference of the insulator. Preferably, these are formed as running all the way around the periphery in the circumferential direction. The insulator may for example be metallized by a surface coating, whereby the metallized zone is provided with properties similar to a metallic material and, in particular, common joining methods for the connection of metallic materials to one another can be carried out.

Sleeves which are used for connecting the insulator to the housing of the device and for connecting the electrical conductor to the insulator may be connected to the metallized zones.

It is particularly advantageous if the first metallized zone and the second metallized zone are arranged at a distance from one another along the direction of axial extent of the insulator.

In order to prevent electrically conductive contact between the two sleeves or between the two likewise electrically conductive metallized zones, these are preferably arranged at a distance from one another along the axial extent of the insulator. Between the two metallized zones there is thus formed a creepage distance, which is intended to prevent an electrical short circuit between the sleeves or the metallized zones. The length of this creepage distance depends on the voltages applied to the sleeves. The higher the voltage level, the longer the creepage distance should be made.

It is also advantageous if the first metal sleeve forms the link to the housing of the device. The first metal sleeve achieves an attachment of the insulator to the housing. The first metal sleeve is on the one hand connected to the metallized zone, for instance by soldering, and on the other hand is connected to the housing, for example by welding. In principle, all known methods for connecting metallic materials can be used, but it must be ensured that the attachment of the metal sleeve to the housing does not lead to damage to the attachment of the metal sleeve to the insulator or vice versa. In particular, if one of the connections is created by a soldering process, the thermal stress caused by a welding process can lead to damage to the soldered connection.

The metal sleeve is preferably dimensioned such that it rests on the metallized zone of the insulator over a sufficiently large area and at the same time a sufficiently large contact area with the housing is formed. The electrical conductor which is fed through the insulator and, on the basis of its principle, is also fed through the metal sleeve must have its radially outwardly directed surface at a sufficient distance from the radially inwardly directed surface of the metal sleeve in order to avoid the occurrence of a short circuit here as well.

A preferred exemplary aspect of the invention is characterized in that the second metal sleeve forms the link to the electrical conductor fed through the insulator.

The second metal sleeve lies against the second metallized zone and is preferably likewise soldered to it. The attachment of the second metal sleeve to the electrical conductor can then in turn be created by a welding process. Here, too, it is important to choose suitable joining methods in a sensible and coordinated sequence in order that connections that are thermally more unstable are not damaged by the heat input of another connection.

It is also preferable if the first metal sleeve and/or the second metal sleeve is connected to their respective metallized zone by a soldering process.

In addition, it is advantageous if the insulator has a smaller outer diameter in the area at least of one of the metallized zones than in the area of the insulator that keeps the two metallized zones at a distance from one another.

The insulator may preferably have shoulders running peripherally in the circumferential direction and extending from the axial ends toward the center of the insulator. The area of the creepage distance may in turn have a larger diameter, so that the area of the creepage distance forms for example a stop for the metal sleeves fitted on from the respective end areas. In this way, on the one hand the positioning of the metal sleeves would be simplified and on the other hand slipping of the metal sleeves, or even contact between them, would be effectively avoided. Even the destruction of a connection between a metallized zone and a metal sleeve would remain without any effect with regard to the electrical isolation of the two metal sleeves due to the larger diameter of the insulator in the area of the creepage distance.

Furthermore, it is advantageous if the insulator is formed from a ceramic material, wherein the surface of the insulator in the area of the metallized zones is processed in such a way that a metallized surface is formed.

It is also expedient if the second metallized zone with the second metal sleeve is arranged within the housing. In addition, it is advantageous if the area of the insulator keeping the two metallized zones at a distance is arranged within the housing.

In the application according to one aspect of the invention, the insulator with its two metallized zones and the soldered-on sleeves is inserted into an opening in the housing. A durable, fluid-tight connection between the metal sleeve and the housing is then created. The area of the insulator facing away from this first metal sleeve and the second metal sleeve are thus forcibly arranged within the housing.

This is particularly advantageous because the untreated area of the insulator which forms the creepage distance is arranged within the housing and thus is not exposed to corrosive influences, which may in particular originate from the environment.

Advantageous developments of the present invention are described in the dependent claims and in the following description of the figures.

### BRIEF DESCRIPTION OF THE DRAWINGS

The invention will be explained in detail below on the basis of an exemplary embodiment with reference to the drawing. In the drawing:

The Figure is a sectional view through a device.

### DETAILED DESCRIPTION OF THE PRESENTLY PREFERRED EMBODIMENTS

The Figure shows an electrical feedthrough 1, which is formed by an electrical conductor 2, which is fed through an insulator 3. The electrical conductor 2 is formed by a metal bolt. The insulator 3 is formed by an annular sleeve, which has a central bore through which the electrical conductor 2 is fed.

The insulator 3 has two zones 4, 5, which have a smaller diameter than the area 6 which keeps the two zones 4, 5 at a distance from one another and forms a creepage distance, which counteracts an electrical short circuit between the two zones 4, 5.

The zones 4, 5 are metallized. Metal sleeves 7, 8 have each been pushed onto one of the metallized zones 4, 5 and durably connected to them, for example by soldering.

The first metal sleeve 7, which is connected to the first metallized zone 4, serves as an attachment of the electrical feedthrough to a housing (not shown). The second metal sleeve 8, which is connected to the second metallized zone 5, serves as an attachment to the electrical conductor 2.

The first metal sleeve 7 is formed in the example of Figure as a cylindrical sleeve and lies with its radially inwardly directed surface on the first metallized zone 4. The housing may for example be attached to the radially outwardly directed surface of the first metal sleeve 7.

The second metal sleeve 8 likewise has a cylindrical portion 9, which is connected to the second metallized zone. In addition, the metal sleeve 8 has an angled portion 10, which is angled radially inward and encloses the electrical conductor 2, so that a connection between the electrical conductor and the second metal sleeve 8 can be created.

The electrical conductor 2 has an end area 11, to which the heating conductor not shown inside the housing not shown can be attached. In addition, the electrical conductor 2 has a second end area 12, to which an electrical supply line can be attached.

The exemplary embodiment of the Figure is in particular not of a limiting nature and serves for illustrating the concept of one aspect of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto

1.-9. (canceled)

10. A device configured to electrically contact of a heating conductor in an exhaust gas line, wherein the heating conductor is arranged within a metal housing and at least one electrical conductor is fed through this housing to contact the heating conductor inside, comprising:
a first metal sleeve;
a second metal sleeve; and
an insulator, which is designed as a sleeve, having a central bore, through which the at least one electrical conductor is fed,
wherein the insulator has on its radially outwardly directed surface a first metallized zone, to which the first metal sleeve is durably connected, and the insulator also has on its radially outwardly directed surface a second metallized zone, to which the second metal sleeve is durably connected.

11. The device as claimed in claim 10, wherein the first metallized zone and the second metallized zone are arranged at a distance from one another along a direction of axial extent of the insulator.

12. The device as claimed in claim 10, wherein the first metal sleeve forms a link to the housing of the device.

13. The device as claimed in claim 10, wherein the second metal sleeve forms a link to the at least one electrical conductor fed through the insulator.

14. The device as claimed in claim 10, wherein the first metal sleeve and/or the second metal sleeve is connected to their respective metallized zone by a soldering process.

15. The device as claimed in claim 10, wherein the insulator has a smaller outer diameter in an area at least of one of the metallized zones than in an area of the insulator that keeps the two metallized zones at a distance from one another.

16. The device as claimed in claim 15, wherein the insulator is formed from a ceramic material, wherein a surface of the insulator in the area of the metallized zones is processed in such a way that a metallized surface is formed.

17. The device as claimed in claim 10, wherein the second metallized zone with the second metal sleeve is arranged within the housing.

18. The device as claimed in claim 15, wherein the area of the insulator keeping the two metallized zones at a distance is arranged within the housing.
